(19) United States
(12) Patent Application Publication
(10) Pub. No.: US 2003/0212206 A1
(43) Pub. Date: Nov. 13, 2003

(54) Polymeric composition prepared from polymers and thermosets

(75) Inventors: Jorn Volker Weiss, Haltern (DE); Werner Grenda, Herne (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/306,220

(22) Filed: Nov. 29, 2002

(30) Foreign Application Priority Data
May 10, 2002 (DE) 101 21 051.9

(51) Int. Cl. C08L 75/00

(52) U.S. Cl. 525/131

(57) ABSTRACT

The invention relates to a polymeric composition prepared from a polymer and a thermoset, in which the thermoset was prepared in the polymer matrix from the starting components of the thermoset.

### BACKGROUND OF THE INVENTION

1. Field of the Invention

The invention relates to a polymeric composition comprising a polymer and a thermoset, where the thermoset was prepared in the polymer matrix from its corresponding starting components.

2. Description of the Related Art

Polymer blends (PBs) are mixtures of two or more polymers or copolymers. These are prepared in order to improve the properties of an underlying polymer. PBs are divided into homologous (HPBs), miscible (MPBs), immiscible, and compatible products, and also polymer alloys. HPBs are mixtures which are composed of two chemically identical polymers which differ only in their molecular weight distributions. The mixtures are always homogeneous, and the mixture is thermodynamically stable. In contrast, MPBs are mixtures of polymers of different chemical structure, these being nevertheless thermodynamically stable. This very unusual situation occurs, for example, where the segments of the macromolecules to be mixed enter into specifically attractive interactions with one another (e.g. hydrogen bonds or dipole-dipole or ion-dipole interactions). The great majority of chemically different polymers are incompatible from a very low degree of polymerization upward, and their incompatibility continues to rise as chain length grows, as can be demonstrated on the basis of statistical/thermodynamic considerations and experimental findings. Decisive factors here relevant to the compatibility of the PBs are particularly their composition and pretreatment. Once the mixing procedure has taken place, if the opportunity for chain-movement and time have been sufficient to permit development of relatively large phase-separated regions, this is mostly observable from clouding of the material. PBs which are then generally termed compatible are those products which appear to the naked eye as homogeneous and whose physical properties are superior to those of the components of the mixture.

Improved compatibility of polymers A and B can be achieved through modification of polymer A by grafting-on small proportions of polymer B, or through adding AB block copolymers. In this system, graft copolymers or block copolymers form the boundary between A phases and B phases, thus tying these to one another. In these cases the term polymer alloys is used. Compatibility may also be brought about by adding certain additives. However, a maximum of homogeneous miscibility is by no means always desirable. For example, impact-modification of polymers such as polystyrene, or the preparation of thermoplastic elastomers, would not be achievable without phase separation. PBs have a very important economic role (Römpp Lexikon Chemie [Römpp's Chemical Encyclopedia]—Version 2.0, Stuttgart/New York: Georg Thieme Verlag 1999).

Polyester surface-coating resins often bear hydroxy groups as a functional group. Both liquid and solid products are used. A main application sector for these resins is the production of surface coatings and coating materials, which are likewise either liquid (e.g. coil coatings) or solid (e.g. powder coatings). Using appropriate hardeners which can react with the OH groups (e.g. polyisocyanates), the polyester resins are generally cured at an elevated temperature after application to a substrate, to give a long-lasting and tough film coating.

Thermosets are plastics which are produced by irreversible and close-knit crosslinking via covalent bonds starting from oligomers or prepolymers, or less often from monomers or polymers. The word “thermosets” here is applied both to the raw materials prior to crosslinking (e.g. reactive resins) and is also used as a collective term for the cured resins, which are mostly amorphous. At low temperatures, thermosets are energy-elastic, and even at relatively high temperatures they cannot undergo viscous flow, but behave elastically with very limited deformability (Römpp Lexikon Chemie [Römpp's Chemical Encyclopedia]—Version 2.0, Stuttgart/New York: Georg Thieme Verlag 1999).

One way of preparing a physical mixture of polymers, and specifically of polyester resin and thermoset, would be to use a considerable amount of mechanical energy to grind the cured thermoset and then to incorporate the ground material into the liquid or molten polyester (e.g. with the aid of a mixer or extruder). Naturally, this does not achieve genuinely homogeneous distribution of the thermoset in the polyester extending to the molecular range, since the maximum achievable fineness of the ground material sets effective limits for polyester/thernoset distribution.

Surprisingly, it has now been found that ideal distribution of the thermoset in polymers, especially in polyesters, occurs if the thermoset is prepared entirely within the polymer or polyester. For this, the appropriate monomers, oligomers, and/or prepolymers are dissolved in the polymer/polyester and then reacted.

The invention provides polymeric compositions comprised of

A) at least one polymer,

B) amounts of from 0.5 to 50% by weight, based on the weight of A and B, of at least one thermoset, prepared through reaction, in the polymer matrix A, of

1) at least one starting component having NH₂ groups and

2) at least one starting component having NCO groups, where B1 and B2 simultaneously and independently have functionality ≧2, and at least one starting component with functionality >2 is present in amounts of from 0.5 to 100% by weight, based on the weight of B.

A preferred embodiment of the invention provides a polymeric composition comprised of

A) at least one polymer having OH groups, preferably a polyester, whose OH functionality is ≧2, and

B) amounts of from 0.5 to 50% by weight, based on the weight of A and B, of at least one thermoset, prepared through reaction, in the polymer matrix A, of

1) at least one starting component having NH₂ groups and

2) at least one starting component having NCO groups, where B1 and B2 simultaneously and independently have functionality ≧2, and at least one starting component with functionality >2 is present in amounts of from 0.5 to 100% by weight, based on the weight of B.

At thermoset contents of from 0.5 to 50% by weight, preferably from 2 to 40% by weight, homogeneous thermoset/polymer compositions are obtained which have physical properties (melting range, Tg, melt viscosity) which differ from those of the substances present separately after physical mixing. In contrast, the chemical reactivity of the polymer which does not participate in the polymerization reaction is retained. The resultant polymeric composition may then be further processed like the matrix polymer.

Suitable polymers A are in principle any of those which are known, e.g. polyolefins, polybutadienes, polystyrenes, polysiloxanes, polyamides, as long as their melting point is not higher than 220° C. Copolymers and block polymers are also suitable as polymer A, an example being styrene-diene copolymers.

Suitable polymers whose functionality is at least 2 are generally any of the polymers which have functionalities of this type, but in particular polyacrylates and polyesters having hydroxy groups.

Preferred polyesters which contain hydroxy groups, are prepared by polycondensation of suitable di- and/or polycarboxylic acids, or the corresponding esters and/or anhydrides, with di- and/or polyols. The condensation takes place in a manner known per se in an inert gas atmosphere at temperatures of from 100 to 260° C., preferably from 130 to 220° C., in the melt, or by an azeotropic method, e.g. as described in Methoden der Organischen Chemie [Methods of Organic Chemistry] (Houben-Weyl); Volume 14/2, pp. 1-5, 21-23, 40-44, Georg Thieme Verlag, Stuttgart, 1963, or in C. R. Martens, Alkyd Resins, pp.51-59, Reinhold Plastics Appl. Series, Reinhold Publishing Comp., New York, 1961. The preferred carboxylic acids for preparing polyesters are aliphatic, cycloaliphatic, aromatic, and/or heterocyclic in nature, and, where appropriate, may have substitution by halogen atoms, and/or may have unsaturation. Examples of these which may be used are: succinic, adipic, suberic, azelaic, sebacic, phthalic, terephthalic, isophthalic, trimellitic, pyromellitic, tetrahydrophthalic, hexahydrophthalic, hexahydroterephthalic, di- and tetrachlorophthalic, endomethylenetetrahydrophthalic, glutaric, and 1,4-cyclohexanedicarboxylic acid and their anhydrides or esters. Particularly highly suitable compounds are isophthalic acid, terephthalic acid, hexahydroterephthalic acid, and 1,4-cyclohexanedicarboxylic acid.

Examples of polyols which may be used are monoethylene glycol, propylene 1,2- or 1,3-glycol, butylene 1,4- or 2,3-glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2,6}]decane (Dicidol), bis(1,4-hydroxymethyl)-cyclohexane, 2,2-bis(4-hydroxycyclohexyl)propane, 2,2-bis[4-(β-hydroxyethoxy) phenyl]propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol, sorbitol, diethylene glycol, triethylene glycol, tetraethylene glycol, dipropylene glycol, polypropylene glycols, polybutylene glycols, xylylene glycol, and/or the neopentyl glycol ester of hydroxypivalic acid. Preferred polyols are monoethylene glycol, neopentyl glycol, Dicidol, cyclohexanedimethanol, trimethylolpropane, and glycerol.

Amorphous polyesters prepared in this way preferably have an OH value of from 15 to 200 mg KOH/g, a Tg of from 35 to 85° C., a melting range from 60 to 110° C., and an acid value of <10 mg KOH/g. The molecular weights are preferably from 2000 to 7000.

(Semi)crystalline polyesters prepared similarly have an OH value of from 15 to 130 mg KOH/g, a Tg of from −50 to 40° C., a melting range from 60 to 130° C., and an acid value of <8 mg KOH/g. The molecular weights are preferably from 1800 to 6500.

Preferred acrylates which may be used and which contain hydroxy groups and have an OH value of from 20 to 150 mg/KOH, a molecular weight of from 1800 to 6000, and a Tg of from 30 to 90° C. are prepared by polyaddition of suitable ethylenically unsaturated monomers. Examples of these monomers are styrene, α-methylstyrene, C₂-C₄₀-alkyl acrylates or C₁-C₄₀-alkyl methacrylates, such as methyl methacrylate, ethyl acrylate, propyl methacrylate, isopropyl methacrylate, n-butyl methacrylate, isobutyl acrylate, tert-butyl methacrylate, pentyl methacrylate, n-hexyl methacrylate, n-heptyl methacrylate, n-octyl acrylate, 2-ethylhexyl acrylate, decyl methacrylate, lauryl methacrylate, palmityl methacrylate, phenoxyethyl methacrylate, phenyl methacrylate, cyclohexyl methacrylate, tert-butylcyclohexyl acrylate, butylcyclohexyl methacrylate, and trimethylcyclohexyl methacrylate, hydroxyalkyl esters of α,β-unsaturated carboxylic acids, e.g. of acrylic acid and/or methacrylic acid, having a primary OH group and a C₅-C₁₈-hydroxyalkyl radical, e.g. hydroxyhexyl acrylate, hydroxyoctyl acrylate, and the corresponding methacrylates, and reaction products of hydroxyethyl (meth)acrylate with caprolactone, and also monomers having secondary OH functions, for example adducts of glycidyl (meth)acrylate with saturated short-chain acids having C₁-C₃-alkyl radicals, e.g. acetic acid or propionic acid.

According to the invention, the thermoset B is prepared from its starting components in the polymer matrix A. The starting components B1 and B2 have functionality of ≧2.0, and in component B there must always be one starting component present whose functionality is ≧2, in amounts of from 0.5 to 100% by weight, based on the weight of B. It is in principle unimportant whether the amino component or the isocyanate component has functionality ≧2, but it is preferable for the isocyanate component having functionality >2 to be used. The approximate molecular weight of the thermosets vary from 2000 to 70000, and are preferably greater than 4000.

In the composition, the amounts generally present of the thermosets B, based on the polymeric composition, are from 0.5 to 50% by weight, particularly preferably from 2 to 30% by weight, based on the weight of A and B.

As component B2 for preparing the thermosets, use may be made of any of the known aliphatic, cycloaliphatic, araliphatic, or aromatic isocyanates or their isocyanurates in pure form or in the form of any desired mixtures with one another. Examples which may be listed are: cyclohexane diisocyanates, methylcyclohexane diisocyanates, ethylcyclohexane diisocyanates, propylcyclohexane diisocyanates, methyldiethylcyclohexane diisocyanates, phenylene diisocyanates, tolylene diisocyanates, bis(isocyanatophenyl)methane, propane diisocyanates, butane diisocyanates, pentane diisocyanates, hexane diisocyanates, such as hexamethylene diisocyanate (HDI) or 1,5-diisocyanato-2-methylpentane (MPDI), heptane diisocyanates, octane diisocyanates, nonane diisocyanates, such as 1,6-diisocyanato-2,4,4-trimethylhexane or 1,6-diisocyanato-2,2,4-trimethylhexane (TMDI), nonane triisocyanates, such as 4-isocyanatomethyl-1,8-octane diisocyanate (TIN), decane di- or triisocyanates, undecane di- or triisocyanates, dodecane di- or triisocyanates, isophorone diisocyanate (IPDI), bis(isocyanatomethylcyclohexyl)methane (H₁₂MDI), isocyanatomethyl methylcyclohexyl isocyanates, 2,5(2,6)-bis(isocyanatomethyl)bicyclo[2.2.1]heptane (NBDI), 1,3-bis(isocyanatomethyl)cyclohexane (1,3-H₆-XDI), or 1,4-bis(isocyanatomethyl) cyclohexane (1,4-H₆-XDI). The list includes all of the regio- and stereoisomers of the isocyanates mentioned by way of example. Preference is given to the use of HDI, IPDI, MPDI, TMDI, 1,3- and 1,4-H₆-XDI, NBDI, and mixtures of HDI and IPDI. Preferred polyureas for the process of the invention are those composed of IPDI, IPDI isocyanurate, HDI, or HDI isocyanurate, or mixtures thereof.

For the purposes of the invention, any of the aliphatic, (cyclo)aliphatic, cycloaliphatic, or aromatic diamines and/or polyamines (C₅-C₁₈) may be used as component B1.

Suitable diamines are 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, isophoronediamine (IPD), 4,7-dioxadecane-1,10-diamine, N-(2-aminoethyl)-1,2-ethanediamine, N-(3-aminopropyl)-1,3-propanediamine, N,N″-1,2-ethanediylbis(1,3-propanediamine), and also hexamethylenediamines, which may be substituted by one or more C₁-C₄-alkyl radicals. Mixtures of the above diamines may also be used. Isophoronediamine is preferably used.

Polyamines having more than 2 NH groups are also suitable, e.g. 4-aminomethyl-1,8-octanediamine, diethylenetriamine, dipropylenetriamine, and tetraethylenepentamine.

The thermosets prepared generally have an NCO/NH₂ ratio of from 0.8 to 1.2:1. If equimolar amounts are used with an NCO/NH₂ ratio of 1: 1, the thermosets obtained in the polymers are continuously crosslinked, strong, and brittle.

For the purposes of the invention, preferred thermosets are those composed of IPD and IPDI, and/or IPDI isocyanurate and/or HDI, and/or HDI isocyanurate. These have molecular weights of above 4000 and contain at least 8% by weight, preferably 20% by weight, particularly preferably 40 to 100% by weight, of isocyanurates and/or amines with functionality >2, preferably isocyanurates, preferably IPDI isocyanurate and/or HDI isocyanurate. Polyureas composed of pure isocyanurates and IPD are also preferred.

In one preferred embodiment of the invention, from 3 to 20% by weight, particularly preferably 4, 5, 6, 7, 8, 9, 10, 11, 12, 13, 14, 15, 16, 17, 18, 19% by weight of thermoset are present in the polymeric composition, in particular in the OH-containing polyester or acrylate.

General method for preparation of the compositions of the invention:

The polymer to be modified is charged to a heatable 2 liter three-necked flask equipped with mechanical stirrer and with two dropping funnels, and is heated to a temperature above its melting point. Each of the monomers/oligomers needed to form the thermoset is charged to the appropriate dropping funnel.

Once the desired reaction temperature has been reached, the reactants are fed, in the selected molar ratio, uniformly into the liquid polymer within a period of from 5 to 30 min, with stirring. Once addition is complete, the reaction mixture is stirred for a further 5-90 min at from 180 to 210° C.

The reaction is preferably carried out under an inert gas (e.g. nitrogen).

For further treatment, while still in hot and liquid form, the resultant reaction mixture is discharged from the reaction flask into a metal dish, in which it cools and solidifies to give a solid product. The resultant product may then be finished using other mechanical operations, e.g. breaking or grinding, as appropriate for its application.

Examples are used below to illustrate the subject-matter of the invention.

### EXAMPLES 1 TO 4

### Polyurea-modified Polyesters and Polyacrylates

| Example | 1 | 2 | 3 | 4 |
|---|---|---|---|---|
| DYNACOLL 7390¹ | 720 | 680 | — | — |
| URALAC 1580² | — | — | 760 | — |
| JOHNCRYL 587³ | — | — | | 720 |
| VESTAMIN IPD⁴ | 30 | 60 | 15 | 30 |
| IPDI/T 1890⁵ | 50 | — | 25 | 50 |
| HDI isocyanurate⁶ | — | 60 | — | — |

(all data in parts by weight)

1. Crystalline polyester, OH value about 30 mg KOH/g, melting point 115° C., molecular weight about 3500, product of Degussa AG

2. Amorphous polyester, OH value about 82 mg KOH/g, Tg about 51° C., product of DSM

3. Polyacrylate, OH value about 75 mg KOH/g, product of SC Johnson Corp., USA

4. Isophoronediamine, H-active equivalent weight 42.6 g/val, product of Degussa AG

5. 1:1 mixture (parts by weight) of:

VESTANAT IPDI (isophorone diisocyanate, NCO content: 37.5%) and VESTANAT T 1890 (isophorone diisocyanurate, NCO content: 18.8%), Degussa products

6. DESMODUR N 3300 (hexamethylene diisocyanurate, NCO content: 21.6%), Bayer AG

### Example 1

720 g of DYNACOLL 7390 polyester are charged to an apparatus as described above, and melted within a period of 45 min with introduction of heat, and heated to a temperature of 180° C., with stirring. The two starting components for the preparation of the thermoset, 30 g of VESTAMIN IPD and 50 g of isocyanate mixture (solution of 25 g of VESTANAT T 1890 (IPDI isocyanurate) and 25 g of VESTANAT IPDI), in each case charged to a dropping funnel, are added dropwise uniformly within a period of 15 min to the polyester melt, the temperature of which is 180° C. The resultant reaction mixture is allowed to continue reacting for a further 20 min at a temperature of 180-190° C. The hot viscous reaction mixture is then transferred to a metal dish and cooled to room temperature. This gives a resin-like, solid, brittle, non-adhesive product.

Examples 2 to 4 are carried out using similar methods.

DE 10221051.9, May 10, 2002, is hereby incorporated by reference.

1. A polymeric composition comprising:
A) at least one polymer,
B) amounts of from 0.5 to 50% by weight, based on the weight of A and B, of at least one thermoset, prepared through reaction, in the polymer matrix A, of
1) at least one starting component having NH₂ groups and
2) at least one starting component having NCO groups, where B1 and B2 simultaneously and independently have functionality ≧2, and at least one starting component with functionality >2 is present in amounts of from 0.5 to 100% by weight, based on the weight of B.

2. The polymeric composition as claimed in claim 1, wherein said at least one polymer A has a functionality ≧2.

3. The polymeric composition as claimed in claim 1, wherein said at least one polymer A has OH groups and an OH functionality ≧2.

4. The polymeric composition as claimed in claim 1,
wherein polymer A is selected from the group consisting of polyolefins, polybutadienes, polystyrenes, polysiloxanes, polyamides, and mixtures thereof.

5. The polymeric composition as claimed in claim 3,
wherein polymer A is selected from the group consisting of polyacrylates and polyesters having OH groups, and mixtures thereof.

6. The polymeric composition as claimed in claim 3,
wherein polymer A is selected from the group consisting of amorphous polyesters, (semi)crystalline polyesters, and mixtures thereof.

7. The polymeric composition as claimed in claim 3,
wherein polymer A is selected from the group consisting of amorphous polyesters with a Tg of 35 to 85° C., a melting range from 60 to 110° C., a molecular weight from 2000 to 7000, and an OH value from 15 to 200 mg KOH/g.

8. The polymeric composition as claimed in claim 3,
wherein polymer A is selected from the group consisting of (semi)crystalline polyesters with a Tg from −50 to 40° C., a melting range from 60 to 130° C., a molecular weight from 1800 to 6500, and an OH value from 15 to 130 mg KOH/g.

9. The polymeric composition as claimed in claim 3,
wherein polymer A is selected from the group consisting of polyesters containing OH groups and comprised of starting components selected from the group consisting of succinic, adipic, suberic, azelaic, sebacic, phthalic, terephthalic, isophthalic, trimellitic, pyromellitic, tetrahydrophthalic, hexahydrophthalic, hexahydroterephthalic, di- or tetrachlorophthalic, endomethylenetetrahydrophthalic, glutaric, 1,4-cyclohexanedicarboxylic acid, their anhydrides and esters, and mixtures thereof.

10. The polymeric composition as claimed in claim 3, wherein polymer A is selected from the group consisting of polyesters containing OH groups and comprised of diols and/or polyols selected from the group consisting of monoethylene glycol, propylene 1,2- or 1,3-glycol, butylene 1,4- or 2,3-glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2 .1.0^{2,6}]decane (Dicidol), bis(1,4-hydroxymethyl)-cyclohexane, 2,2-bis(4-hydroxycyclohexyl)propane, 2,2-bis[4-(β-hydroxyethoxy) phenyl]propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol, sorbitol, diethylene glycol, triethylene glycol, tetraethylene glycol, dipropylene glycol, polypropylene glycols, polybutylene glycols, xylylene glycol, the neopentyl glycol ester of hydroxypivalic acid, and mixtures thereof.

11. The polymeric composition as claimed in claim 3,
wherein polymer A is selected from the group consisting of polyacrylates containing OH groups with an OH value of from 20 to 150 mg KOH/g, a molecular weight of from 1800 to 6000, and a Tg of from 30 to 90° C.

12. The polymeric composition as claimed in claim 1,
wherein B1 is selected from the group consisting of aliphatic, cycloaliphatic, araliphatic and aromatic, isocyanates and isocyanurates, and mixtures thereof.

13. The polymeric composition as claimed in claim 1,
wherein B1 is selected from the group consisting of cyclohexane diisocyanates, methylcyclohexane diisocyanates, ethylcyclohexane diisocyanates, propylcyclohexane diisocyanates, methyldiethylcyclohexane diisocyanates, phenylene diisocyanates, tolylene diisocyanates, bis(isocyanatophenyl)methane, propane diisocyanates, butane diisocyanates, pentane diisocyanates, hexane diisocyanates, such as hexamethylene diisocyanate (HDI) or 1,5-diisocyanato-2-methylpentane (MPDI), heptane diisocyanates, octane diisocyanates, nonane diisocyanates, such as 1,6-diisocyanato-2,4,4-trimethylhexane, 1,6-diisocyanato-2,2,4-trimethylhexane (TMDI), nonane triisocyanates, 4-isocyanatomethyl-1,8-octane diisocyanate (TIN), decane di- or triisocyanates, undecane di- or triisocyanates, dodecane di- or triisocyanates, isophorone diisocyanate (IPDI), bis(isocyanatomethylcyclohexyl)methane (H₁₂MDI), isocyantomethyl methylcyclohexyl isocyanates, 2,5(2,6)-bis(isocyanato-methyl)bicyclo[2.2.1]heptane (NBDI), 1,3-bis(isocyanatomethyl)cyclohexane (1,3-H₆-XDI), 1,4-bis(isocyanatomethyl)cyclohexane (1,4-H₆-XDI), their isocyanurates, and mixtures thereof.

14. The polymeric composition as claimed in claim 1,
wherein B1 is selected from the group consisting of isophorone diisocyanate (IPDI), hexamethylene diisocyanate (HDI), their isocyanurates, and mixtures thereof.

15. The polymeric composition as claimed in claim 1,
wherein B2 is selected from the group consisting of aliphatic amines, cycloaliphatic amines, araliphatic amines, aromatic diamines, and mixtures thereof.

16. The polymeric composition as claimed in claim 1,
wherein B2 is selected from the group consisting of 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, isophoronediamine (IPD), 4,7-dioxadecane-1,10-diamine, N-(2-aminoethyl)-1,2-ethanediamine, N-(3-aminopropyl)-1,3-propanediamine, N,N″-1,2-ethanediylbis(1,3-propanediamine), hexamethylenediamines, which may be substituted by one or more C₁-C₄-alkyl radicals, and mixtures thereof.

17. The polymeric composition as claimed in claim 1,
wherein thermoset B comprises IPDI, HDI isocyanurate, and isophoronediamine (IPD).

18. The polymeric composition as claimed in claim 1,
wherein thermoset B comprises the isocyanurate of IPDI and IPD.

19. The polymeric composition as claimed in claim 1,
wherein thermoset B comprises IPDI, IPDI isocyanurate and IPD.

20. The polymeric composition as claimed in claim 1,
wherein thermoset B comprises IPDI isocyanurate, HDI, and IPD.

21. The polymeric composition as claimed in claim 1,
wherein thermoset B comprises HDI, HDI isocyanurate, and IPD.

22. The polymeric composition as claimed in claim 1,
wherein thermoset B comprises IPDI isocyanurate, HDI isocyanurate, and IPD.

23. The polymeric composition as claimed in claim 1,
wherein thermoset B comprises IPDI, IPDI isocyanurate, HDI, and HDI isocyanurate.

24. The polymeric composition as claimed in claim 1,
wherein the reaction to form thermoset B takes place with an NCO/NH₂ ratio of from 0.8 to 1.2:1.

25. The polymeric composition as claimed in claim 1,
wherein thermoset B has a molecular weight of at least 4000 and comprises at least 8% by weight of isocyanurate(s) and/or amine(s) with functionality >2.

26. The polymeric composition as claimed in claim 1,
wherein from 2 to 30% by weight of thermoset B, based on the weight of A and B, is present in the polymeric composition.

27. A coating composition, adhesive, sealant or insulating material comprising the polymeric composition as claimed in claim 1.

28. A process for preparing a polymeric composition comprising:
A) at least one polymer,
B) amounts of from 0.5 to 50% by weight, based on the weight of A and B, of at least one thermoset, comprising reacting in the polymer matrix A, of
1) at least one starting component having NH₂ groups, and
2) at least one starting component having NCO groups, where B1 and B2 simultaneously and independently have functionality ≧2, and at least one starting component with functionality >2 is present in amounts of from 0.5 to 100% by weight based on the weight of B,
in the melt or in solvent.

29. The polymeric composition as claimed in claim 1, wherein thermoset B has a molecular weight of 4000 and comprises at least 20% by weight of isocyanurate(s) and/or amine(s) with functionality >2.

30. The polymeric composition as claimed in claim 1, wherein thermoset B has a molecular weight of 4000 and comprises 40 to 100% by weight of isocyanurate(s) and/or amine(s) with functionality >2.

31. The polymeric composition as claimed in claim 1, wherein from 30 to 20% by weight of thermoset B, based on the weight of A and B, is present in the polymeric composition.
